(19) United States
(12) Patent Application Publication
(10) Pub. No.: US 2021/0372444 A1
(43) Pub. Date: Dec. 2, 2021

(54) Tru-Clip

(71) Applicant: The Government of the United States of America, as represented by the Secretary of the Navy, Arlington, VA (US)

(72) Inventors: Casey J. Staidl, Virginia Beach, VA (US); Jerrod K. Jenkins, Cypress, TX (US); Ashley N. Figert, Virginia Beach, VA (US)

(21) Appl. No.: 17/337,109

(22) Filed: Jun. 2, 2021

Related U.S. Application Data
(60) Provisional application No. 63/033,819, filed on Jun. 2, 2020.

(51) Int. Cl. F16B 2/22

(52) U.S. Cl. CPC F16B 2/22; H04B 1/3833

(57) ABSTRACT

A clip holding an adapter housing to a radio includes an antenna end having an outer ring and annular inner ring shallower than the outer ring, thereby collectively forming an L-shaped annular cross-section defining an annular seat on an interior portion of the antenna end; an adapter end includes a partial annular ring with a break opening the ring away from the antenna end, thereby forming a clip which is configured to releasably retain an adapter housing cord; and a connecting portion rigidly coupling the antenna end to the adapter end.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing NC 104176.

### FIELD OF INVENTION

The present invention relates generally to strengthening adapters, and more particularly to an additively manufactured clip to strengthen the connection between a radio and its housing adapter.

### BACKGROUND

Existing conventional radio designs may include a plastic housing adapter as shown in FIGS. 1-3. During normal use, this expensive part can frequently crack or otherwise fail, often at the retaining end as shown in close-up in FIG. 1. This failure, because the part includes integrated electronics, results in a disproportionately large replacement expense for such a minor structural issue.

### SUMMARY OF INVENTION

Presented herein is a structure for extending the life of these housing adapters by reducing stress on the part, and by providing redundant attachment means for the adapter to the radio.

According to one aspect of the invention, a clip for holding an adapter housing to a radio includes an antenna end having an outer ring having a first depth and annular inner ring having a second depth, the second depth being smaller than the first depth, thereby collectively forming an L-shaped annular cross-section defining an annular seat on an interior portion of the antenna end; an adapter end includes a partial annular ring with a break opening the ring away from the antenna end, thereby forming a clip which is configured to releasably retain an adapter housing cord; and a connecting portion rigidly coupling the antenna end to the adapter end.

Optionally, the clip is in combination with a radio. The annular antenna end is seated against a portion of the radio and rigidly compressed thereagainst by an antenna threadably coupled to the radio and against the L-shaped annular seat.

Optionally, the clip is additively manufactured to fit a particular radio design.

The foregoing and other features of the invention are hereinafter described in greater detail with reference to the accompanying drawings.

### BRIEF DESCRIPTION OF THE DRAWINGS

FIG. 1 shows a photograph of a broken conventional radio adapter housing;

FIG. 2 shows a conventional radio, antenna, and adapter housing with an exemplary clip fixedly attached to the radio by the antenna and releasably holding the adapter housing to the radio;

FIG. 3 shows another view of the conventional radio with an exemplary clip;

FIG. 4 shows a perspective view of an exemplary clip;

FIG. 5 shows a top view of an exemplary clip;

FIG. 6 shows a bottom view of an exemplary clip;

FIG. 7 shows a first side view of an exemplary clip;

FIG. 8 shows a second side view of an exemplary clip;

FIG. 9 shows front view of an exemplary clip;

FIG. 10 shows a back view of an exemplary clip.

### DETAILED DESCRIPTION

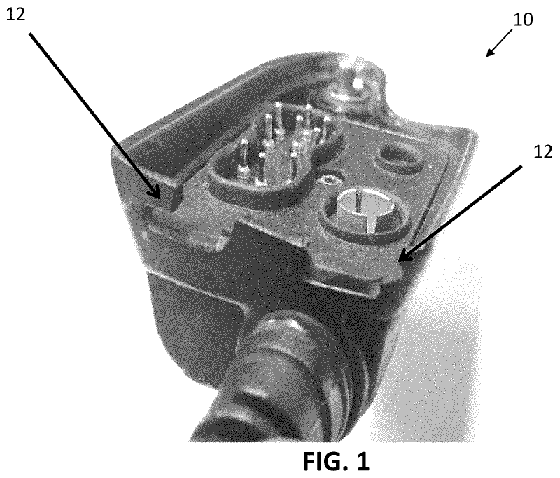

Referring to FIG. 1, headset/microphone plastic housings 10 for radio communication devices can be prone to stress and cracking as indicated at 12. These cracks can result in loss of functionality of the device because the housing acts as a retaining element for clipping the microphone/headset device to the main body of the radio communication device. Typically, replacement necessitates purchase of an entirely new Universal Adapter cable that can be relatively expensive (e.g., $600 per unit). Such replacement parts are needed often due to the demands of the environment and the quantity of such radio communications devices used.

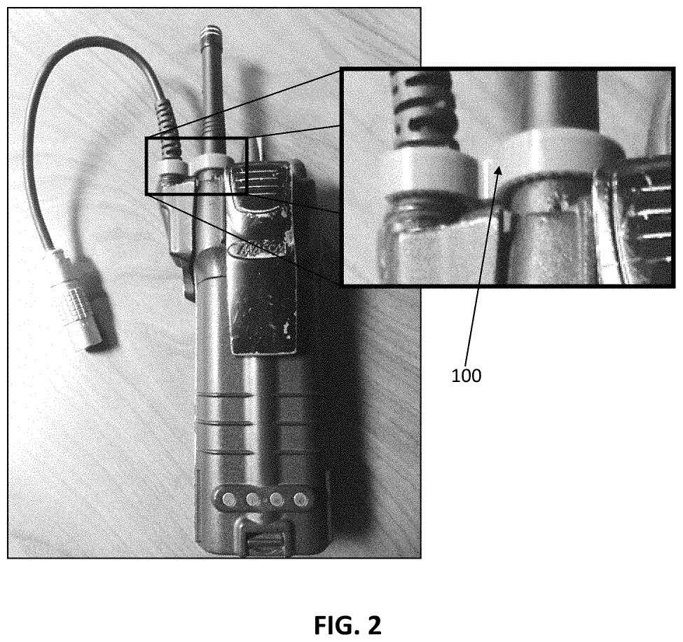

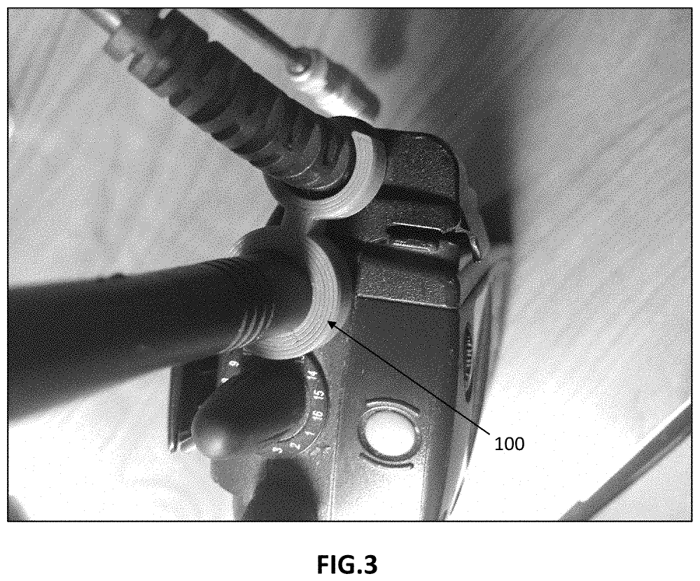

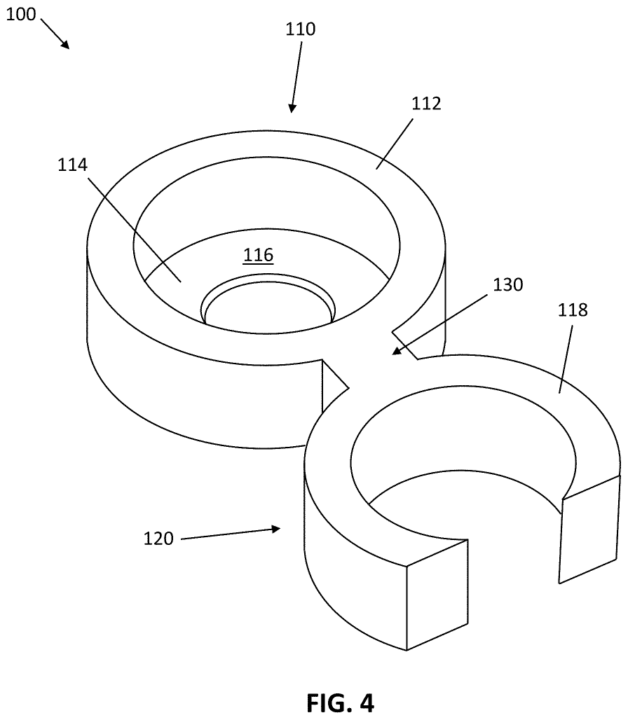

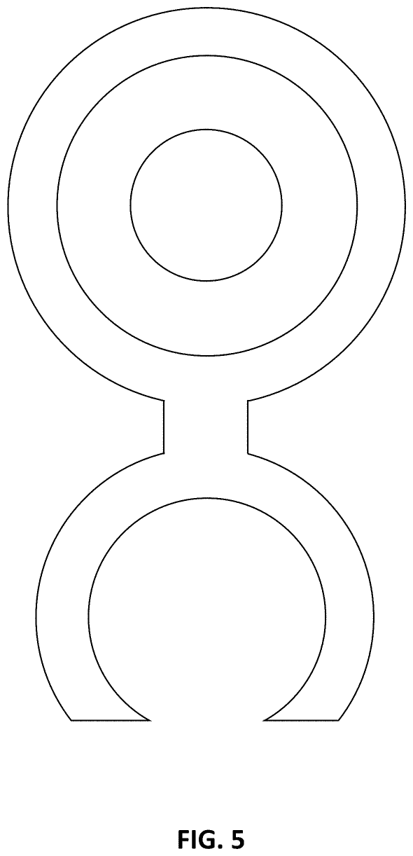

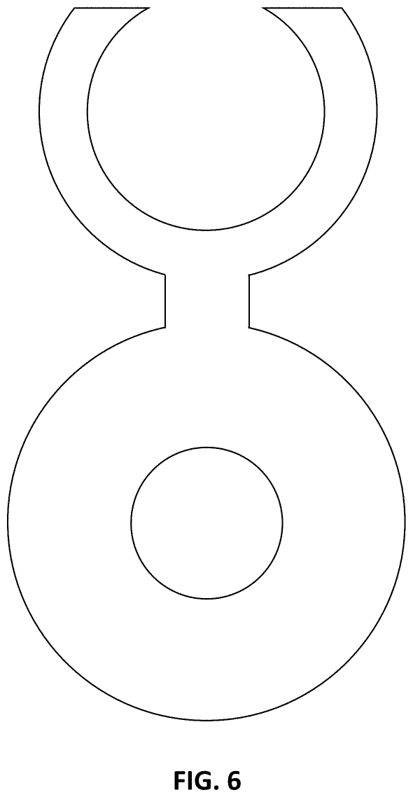

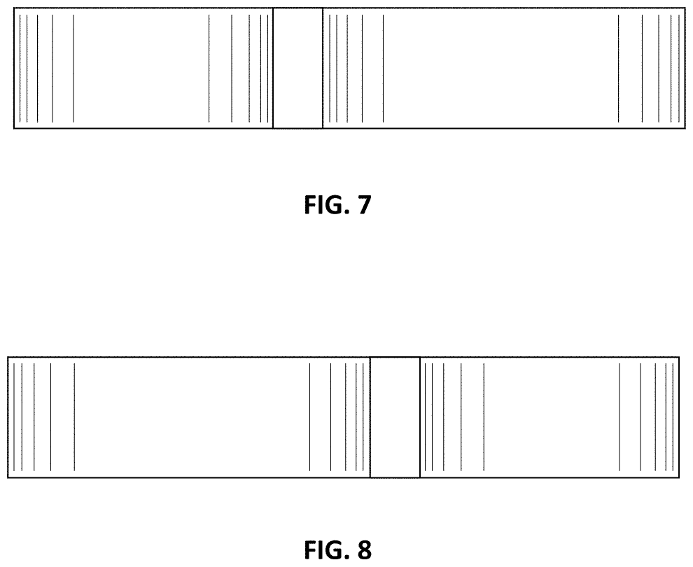

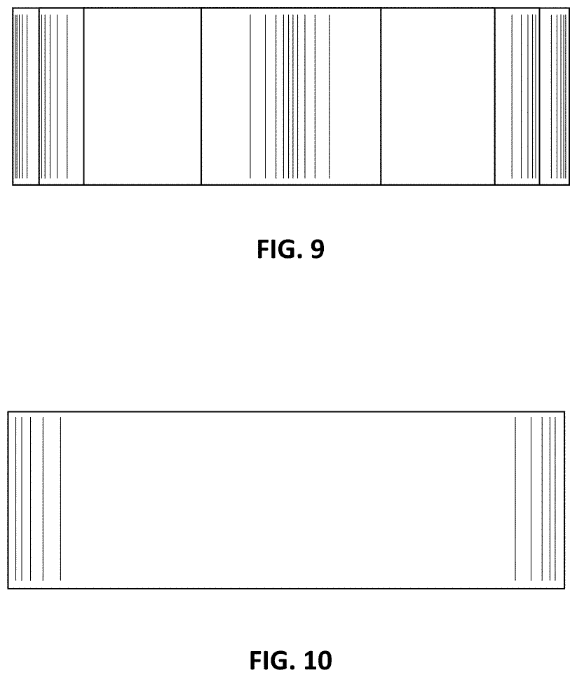

Therefore, referring now to FIGS. 2-10, an exemplary clip 100 can be used to hold a defective/cracked microphone/headset adapter to a radio communications device. The clip includes an antenna end 110 and an adapter end 120 generally forming a “figure eight” pattern and joined by a connecting portion 130.

The antenna end 110 includes an annular outer ring 112 having a first depth and annular inner ring 114 having a second depth, the second depth being smaller than the first depth, thereby forming an L-shaped annular cross-section. This L-shaped cross-section defines an annular seat 116 on the interior of the antenna end 110. The shape of the annular end 110 is configured to seat firmly against a portion of the radio communications device in which a detachable antenna is normally seated. In use, the annular end is seated between the main body of the radio communications device and the detachable antenna, with the detachable antenna holding the antenna end 110 of the clip 100 to the radio communications device. In particular, the screw of the antenna passes through the hole 118 of the antenna end 110 and into the radio communications device.

The adapter end 120 includes a partial annular ring 118 with a break opening the ring away from the antenna end, thereby forming a clip which releasably retains the adapter housing cord.

Overall, the clip 100 may be approximately two inches in length and may be formed by any appropriate means including injection molding. However, the clip is preferably made via additive manufacturing and is sized and shaped to securely fit a particular model of radio and adapter.

Other optional configurations may include strengthening webs between the two ends 110, 120. These strengthening webs may make the overall shape of the adapter a smooth “8” or infinity-shape.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A clip for holding an adapter housing to a radio comprising:
an antenna end having an outer ring having a first depth and annular inner ring having a second depth, the second depth being smaller than the first depth, thereby collectively forming an L-shaped annular cross-section defining an annular seat on an interior portion of the antenna end;
an adapter end includes a partial annular ring with a break opening the ring away from the antenna end, thereby forming a clip which is configured to releasably retain an adapter housing cord; and
a connecting portion rigidly coupling the antenna end to the adapter end.

2. The clip of claim 1 in combination with a radio,
wherein the annular antenna end is seated against a portion of the radio and rigidly compressed thereagainst by an antenna threadably coupled to the radio and against the L-shaped annular seat.

3. The clip of claim 1, wherein the clip is additively manufactured to fit a particular radio design.
